(19) United States
(12) Patent Application Publication
(10) Pub. No.: US 2011/0199015 A1
(43) Pub. Date: Aug. 18, 2011

(54) DIAMOND COMPOSITE AS ILLUMINATION SOURCE

(75) Inventors: Adrian E. Mendez, Aiken, SC (US); Mark A. Prelas, Columbia, MO (US); Tushar K. Ghosh, Columbia, MO (US)

(73) Assignee: THE CURATORS OF THE UNIVERSITY OF MISSOURI, Columbia, MO (US)

(21) Appl. No.: 12/705,322

(22) Filed: Feb. 12, 2010

(51) Int. Cl. H05B 37/00; C09K 11/61; C09K 11/68

(52) U.S. Cl. 315/291; 252/301.4 H

(57) ABSTRACT

The present disclosure provides a new diamond composite comprising a diamond material doped with a preselected transition metal or metal compounds as an illumination source with broadband white light luminosity, high efficiency, and enhanced life span. The present disclosure also provides a new method of diffusing dopants (such as transition metal or metal compounds) into an intended material (such as a diamond material).

This application claims priority to U.S. Provisional patent application Ser. No. 12/705,322, entitled “Diamond Composite As Illumination Source”, filed Feb. 12, 2009 with Attorney Docket No. 07UMC016-020prov with the identical inventors to the present application. The contents of said application are incorporate herein.

### GRANT STATEMENT

None.

### FIELD

The present disclosure relates to an illumination source, and more specifically, the present disclosure relates to modified or doped diamond material as illumination source.

### BACKGROUND

The incandescent lamp is a traditional illumination source that works by an electrical current passing through a thin filament and heating it to produce light in an enclosed glass bulb. Due to its low efficiency and life span, incandescent light bulbs are gradually being replaced in many applications by fluorescent lights, high-intensity discharge lamps and, most recently, LEDs.

Incandescent light sources have been the primary source since the inception of electrical lighting. The efficacy of an incandescent light, which is about 1% to 2% energy efficient, is approximately 20 Lumens/Watt. It typically has a lifetime of 2000 hours. A 40% energy efficient sodium lamp on the other hand has a luminous efficacy of 120 lumens/watt and a lifetime of about 5000 to 8000 hours. However, the color of light from a sodium lamp is yellowish and not pleasing. The maximum achievable efficacy when using three wavelengths where the human eye is most sensitive (455 nm, 555 nm and 610 nm) will result in a maximum efficacy of 300 lumens/watt with 100% radiant power efficiency.

The sources with a combination of good efficacy and a pleasing spectrum are LEDs and fluorescent lamps. LED's are about 60% to 80% energy efficient and can produce three colors close to the optimum wavelengths and are able to achieve an efficacy of 100 to 120 lumens/Watt or slightly better. LEDs have a lifetime of about 10000 hours. Fluorescent lamps have an energy efficiency of nearly 25% and can achieve an efficacy of about 100 Lumens/Watt. Fluorescent lamps have a lifetime of about 5000 hours. Achieving an efficacy of about 200 lumens per Watt will require a high efficiency light source that produces a light spectrum that matches the sensitivity of the human eye with a lifetime of 10000 hours or better.

Therefore, there is a need to provide a new and improved illumination source having improved luminosity and efficiency, enhanced life span, and easy packaging.

### SUMMARY

The present disclosure provides a novel illumination source comprising a diamond material doped with one or a mixture of metal dopants (such as metals or metal compounds). According to one embodiment of the present disclosure, the diamond composite comprises of a diamond material (such as film or particles) and metal (or metal compound) particles, selected from transition metals or a mixture thereof, diffused within the diamond material at concentrations ranging from about 0.01 ppm to about 10,000 ppm.

The present disclosure also provides a novel method of diffusing one or a mixture of dopants (such as the transition metals or metal compounds) into a preselected hosting material (such as a diamond material). The diffusion method includes the steps of 1) mixing a preselected hosting material and preselected metal dopant(s) into a mixture, 2) placing the mixture in a vacuum environment, and 3) simultaneously, treating the mixture with heat at a preselected temperature, laser of a preselected wavelength at a preselected intensity, and a preselected voltage for a pre-determined time period. The temperature range, the wavelength, the intensity, the voltage, and the duration can be selected in accordance with the physical properties of the dopants.

The present disclosure further provides a novel method of emitting light from a diamond composite comprising diamond materials diffused with transition metal dopants. The illumination method includes the step of providing a driving voltage and current flows crossing a preselected diamond composite comprising diamond materials diffused with transition metal dopants. The method can further include the steps of 1) pressing the diamond composite into a pellet of a preselected size and shape and 2) placing the doped diamond pellet between a set of electrical contacts.

### BRIEF DESCRIPTION OF DRAWINGS

FIGS. 1(A) and 1(B) are scanning electron microscope (SEM) micrographs of an exemplary diamond composite crystal that has been fabricated using the device shown in FIG. 5, in accordance with various embodiments of the present disclosure.

FIGS. 1(C), 1(D) and 1(E) are graphs illustrating energy dispersive spectroscopy (EDS) surface analysis for the exemplary diamond composite crystal shown in FIGS. 1(A) and 1(B), in accordance with various embodiments of the present disclosure.

FIGS. 2(A) and 2(B) are back-scattered electron (BSE) micrographs of a cross-section of the exemplary diamond composite crystal shown in FIGS. 1(A) and 1(B), in accordance with various embodiments of the present disclosure.

FIG. 3 is a SEM micrograph of another exemplary diamond composite crystal that has been fabricated using the device shown in FIG. 5, in accordance with various embodiments of the present disclosure.

FIG. 4 is a graph illustrating an EDS surface analysis for the exemplary diamond composite crystal shown in FIG. 3, in accordance with various embodiments of the present disclosure.

FIG. 5 is a schematic illustration of a device for diffusing a preselected dopant, e.g., a transition metal such as chromium, into a hosting material, e.g., a diamond material to produce composite material, such as that shown in FIGS. 1(A), 1(B) and 3, in accordance with various embodiments of the present disclosure.

FIG. 6 is an electrical circuit for illuminating a luminescent diamond composite structure fabricated using the device shown in FIG. 5, such as that shown in FIGS. 1(A), 1(B) and 3, in accordance with various embodiments of the present disclosure.

### DETAILED DESCRIPTION

Unless otherwise defined, all technical and scientific terms used herein have the same meaning as commonly understood by one of ordinary skill in the art to which this disclosure belongs. All publications, patent applications, patents, and other references mentioned herein are incorporated by reference in their entirety.

In various embodiments, the present disclosure provides diamond composite, which can be used as an illumination source to provide a white light with a broad wavelength span, e.g., wavelengths within the white light spectrum, adjustable luminosity, i.e., the illumination intensity is adjustable, improved electrical efficiency, enhanced life span, e.g., approximately 10,000 hours, and flexible sizes. Generally, the diamond composite comprises 1) a preselected diamond material, and 2) a preselected metal dopant, which can be one or a mixture of certain transition metals or metal compounds, whereas, in various implementations, the metal dopant is diffused into the diamond at a concentration ranging between about 0.01 ppm to about 10,000 ppm, e.g., about 100 ppm to about 5,000 ppm.

The preselected diamond material can be any suitable diamond material regardless of its optical quality, for example, in various embodiments an industrial diamond can be utilized to provide the diamond material for its reduced cost. The preselected diamond material can be in a variety of sizes and shapes, such as a diamond film or diamond particles with the particle size ranging from about 4 nm to about 800 μm.

In various embodiments, the metal dopant can be any transition metal such as chromium, iron, nickel, cobalt, vanadium, manganese, copper, titanium, zinc, gallium, arsenic, selenium, zirconium, niobium, molybdenum, technetium, ruthenium, rhodium, palladium, silver, cadmium, indium, antimony, tellurium, hafnium, tantalum, tungsten, rhenium, osmium, iridium, platinum, gold, mercury, thallium, bismuth, or polonium. The metal dopant can be in its metal form or as a metal compound, such as a salt (—Cl, B, S) or an oxide.

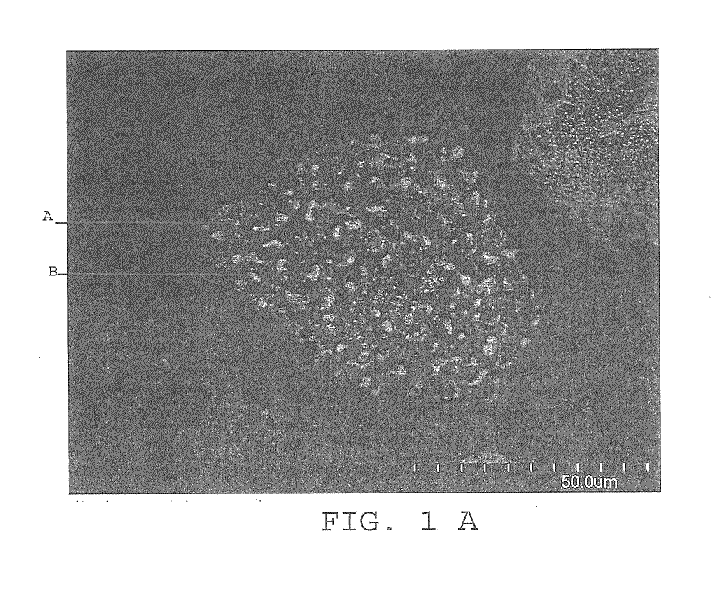

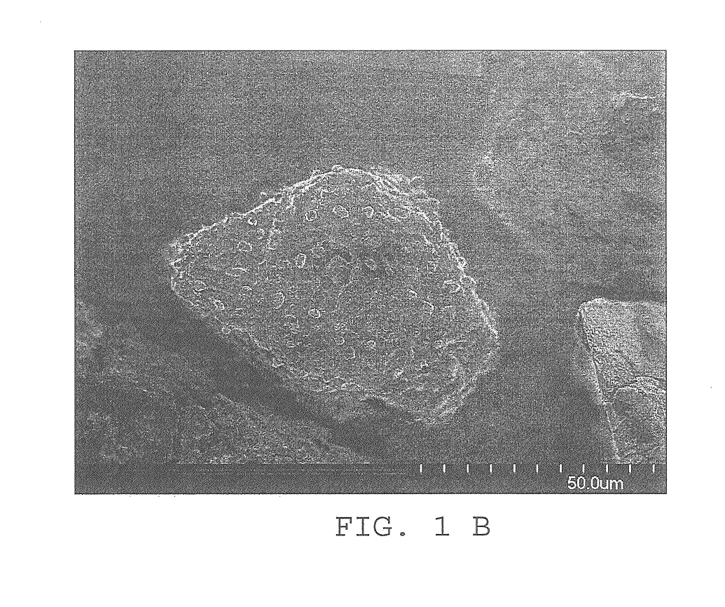

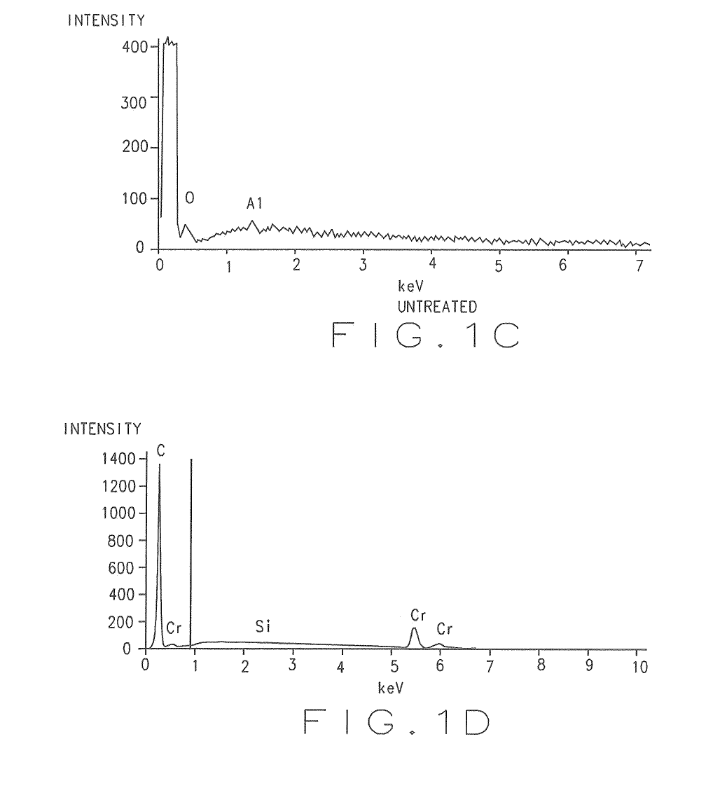

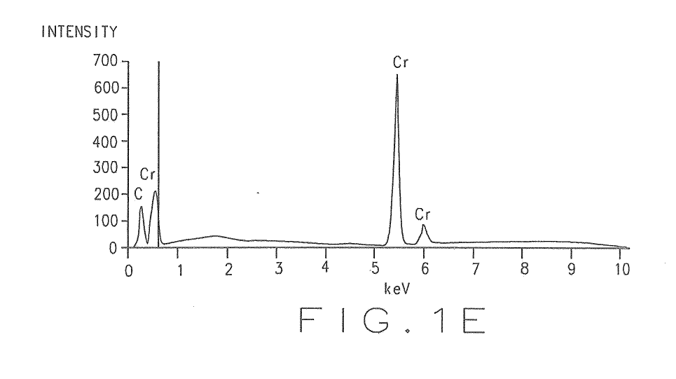

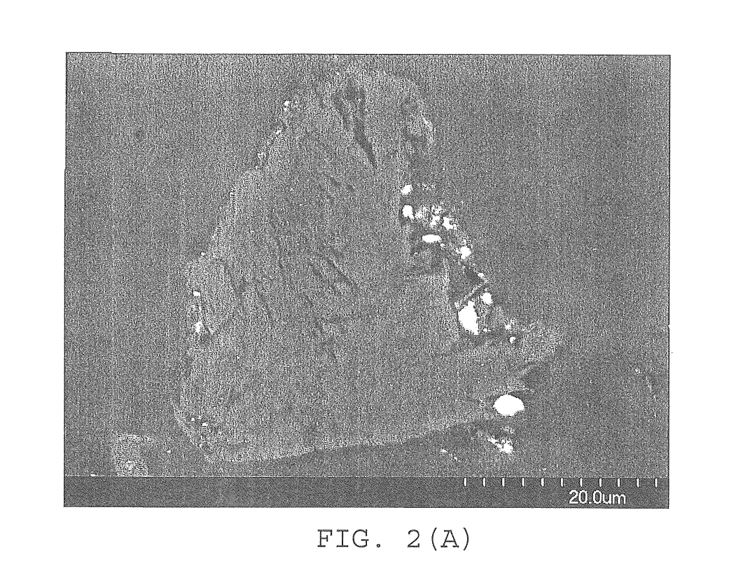

FIGS. 1(A) and 1(B) are exemplary scanning electron microscope (SEM) micrographs of a crystal from a diamond composite structure, e.g., diamond composite structure 48 described below, fabricated from diamond particles doped with a transition metal, e.g., chromium, using the devices and methods described herein. FIGS. 1(D) and 1(E) are graphs illustrating the SEM/EDS surface analysis of the exemplary diamond composite crystal shown in FIGS. 1(A) and (B), where the bright spots in the SEMs represent the diffused transition metal at various concentrations. More particularly, FIG. 1(A) shows the crystal micrograph under a higher voltage, e.g., 12,000V, which provides deeper penetration into the crystal, thereby illustrating the successful doping of the diamond material using the devices and methods described herein. FIG. 1(B) shows the same crystal with a lower voltage, e.g., 1,000V, which better displays the surface characteristics of the crystal. And, FIG. 1(C) shows the EDS analysis for an exemplary diamond particle prior to being doped with the transition metal, FIG. 1(D) shows the EDS plot for a diamond particle A (shown in FIG. 1(A)) doped with the transition metal at a low concentration, or intensity, and FIG. 1(E) shows another diamond particle B (shown in FIG. 1(A)) doped with the transition metal at a higher concentration, or intensity.

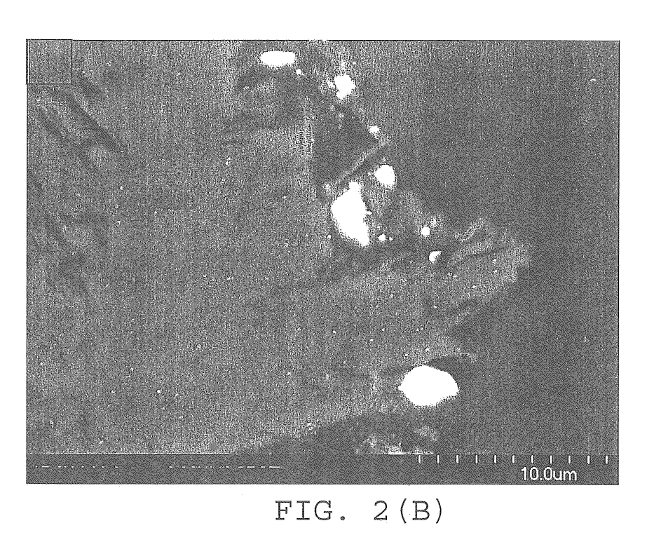

FIGS. 2(A) and 2(B), are back-scattered electron (BSE) micrographs of a cross-section of the exemplary diamond composite crystal, shown in FIGS. 1(A) and 1(B), comprising diamond particles doped with a transition metal, e.g., chromium. Particularly, FIGS. 2(A) and 2(B) show the size range and depth distribution of the diffused transition metal on and within the diamond composite crystal, with FIG. 2(A) in 20 μm scale and FIG. 2(B) in 10 μm scale.

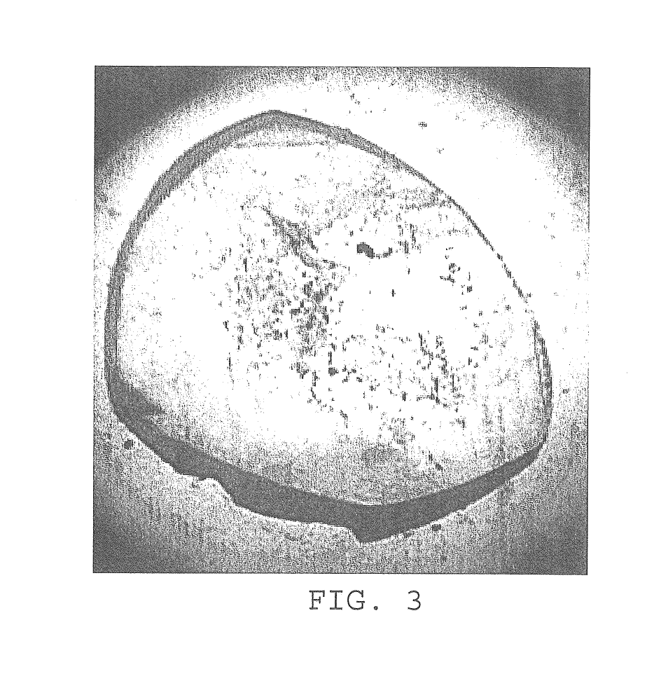

FIG. 3, is an exemplary SEM micrograph of a crystal from a diamond composite structure, e.g., diamond composite structure 48 described below, fabricated from a diamond film doped with a transition metal, e.g., chromium, using the devices and methods described herein. The exemplary crystal is larger crystal than those of preceding figures having a dimension of about 3 mm×3 mm. FIG. 3 shows that even in a larger crystal the intake of the transition metal, e.g., Cr, is quite high. When viewed in color, a rainbow section (area indicated by circle 10) is apparent in FIG. 3 indicating a high transition metal, e.g., Cr, deposition.

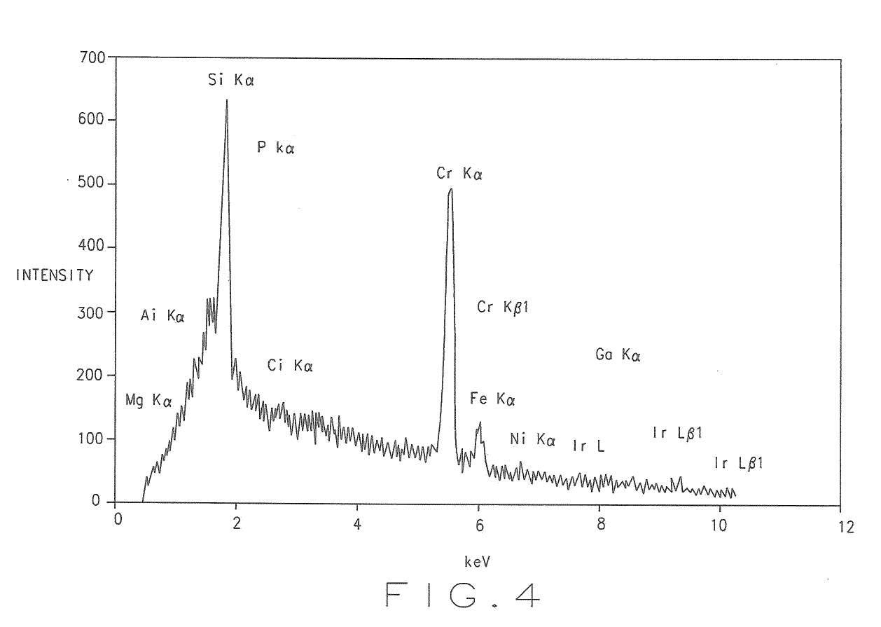

Referring to FIG. 4, FIG. 4 is the EDS surface analysis of the diamond film crystal of FIG. 3 doped with a transition metal, e.g., chromium, which shows similar shifts and peaks as those in the EDS surface analysis graphs shown in FIGS. 1(D) and 1(E) indicating the high intensity, i.e., concentration, of the transition metal, e.g., Cr, deposition into the crystal with regard to various other impurities within the crystal.

The present disclosure further teaches a method of diffusing a preselected dopant into a hosting material, such as a diamond material. In various embodiments, the diffusion method includes the steps of 1) mixing a preselected hosting material with a preselected dopant to produce a substantially homgenous mixture, 2) placing the mixture in a vacuum environment, 3) treating the mixture with heat at a preselected temperature range, e.g., between 400° C. and 1600° C., a laser at a preselected wavelength, e.g., between 200 nm and 1000 nm, and a driving voltage at a preselected range, e.g., between 10V and 2000V, for a pre-determined time period, e.g., between 1 hour and 1 week. In various embodiments, the method includes treating the mixture with heat between approximately 800° and 900° C., a laser beam having a wavelength of approximately 670 nm, and a driving voltage between approximately 200V and 400V, for approximately 12 hours. In various implementations, the process can be employed to diffuse any metal dopant into any wideband gap materials, such as diamond, SiC, Si, AlN, or BN materials.

In the aforesaid mixing step, any standard mixing method can be employed. For example, when diamond particles are used as hosting material, the mixture can be milled, while when a diamond film is used as the hosting material, the dopant can be pressed onto the film. In the aforesaid placing step, the environment can be under about 0.01 Torr to about 1×10⁻⁸ Torr vacuum. In the aforesaid treatment step, the temperature range, the laser wavelength and intensity, and the voltage range can be selected according to the physical properties of the particular dopants.

FIG. 5 is a schematic illustration of a diffusion device 18 that is structured and operable to diffuse a preselected metal dopant into a hosting material to produce a resulting composite structure having a high concentration level of the dopant. For example, in various embodiments, the diffusion device 18 can be utilized to diffuse a metal, such as chromium or any other suitable metal, into a diamond material to produce a luminescent diamond composite structure having a high concentration of the metal such that the resulting diamond composite structure will generate broadband white light when a voltage is applied across the resulting luminescent diamond composite structure. In various embodiments, as shown in FIG. 5, the diffusion device 18 generally includes a vacuum chamber 19 and a doping device 20 that is disposed within the vacuum chamber 19. The doping device 20 includes a translucent quartz tube 24, a heating element 26, a pair of opposing electrodes 28 and 30, and one or more laser sources 34. In the exemplary embodiments wherein the hosting material is a diamond material, e.g., a diamond powder or diamond film, the diamond/dopant mixture 22 is placed within the translucent quartz tube 24, through which one or more laser beams 32, generated by the one or more laser sources 34 can shine.

The heating element 26 is placed within the vacuum chamber 19 such that it is operable to elevate the temperature of the entire vacuum chamber 19. Electrode 28 is structured to seal a lower end of the quartz tube 24 and acts as a conductor for a negative voltage bias applied thereto. Electrode 30 is structured to seal an upper end of the quartz tube 24 and acts as a conductor for a positive voltage bias applied thereto. Alternatively, electrode 28 can act as a conductor for a positive voltage bias applied thereto, and electrode 30 can act as a conductor for a negative voltage bias applied thereto. In various embodiments, the electrodes 28 and 30 can comprise graphite, however, in various other embodiments, the electrodes 28 and 30 can comprise any electrically conductive metal. In various embodiments, pressure is applied by one or more springs (not shown) to the electrodes 28 and 30 to bias the electrodes against the diamond/dopant mixture 22 to apply a compressive force to the mixture 22 sufficient to prevent the dopant from separating from the diamond material as the dopant is being diffused into the diamond material, via the diffusion device 18, as described herein. Alternatively, the electrodes 28 and 30 can have threads along their outer circumference that mate with threads on the interior surface of the quartz tube 24. By applying torque to the threadingly engaged electrodes 28 and 30 and the quartz tube 24 sufficient compressive pressure can be applied by the electrodes 28 and 30 to the diamond/dopant mixture 22 to prevent the dopant from separating from the diamond material as the dopant is being diffused into the diamond material, via the diffusion device 18, as described herein.

The following example illustrates how the diffusion device 18, as describe above, can be utilized to fabricate a diamond composite structure doped with Chromium Chloride. First, a diamond starting material, in a powder form having particle size of approximately 30 micrometers, is mixed with a Chromium Chloride salt, e.g., using a mortal and pestle, thereby creating substantially homogenous mixture, wherein the Chromium Chloride (CrCl) salt and the starting diamond particles are in physical contact with each other. Particularly, the diamond powder and CrCl salt dopant are mixed to provide a ratio of dopant (CrCl) to the starting diamond particles of approximately 3:1 (weight). Other ratios can also be used according to the desired end product. Second, the mixture sample 22 is compacted to provide a sample tablet and the sample tablet 22 is placed inside the quartz tube 24, with the pair of electrodes 28 and 30, e.g., graphite electrodes 28 and 30, inserted into the opposing ends of the quartz tube 24 at opposite sides of the sample 22. As described above, the electrodes 28 and 30 provide the electrical contact for applying a voltage across the sample 22 and are bias against the sample 22 with a force sufficient to prevent the dopant from separating from the diamond material as the dopant is being diffused into the diamond material, via the diffusion device 18.

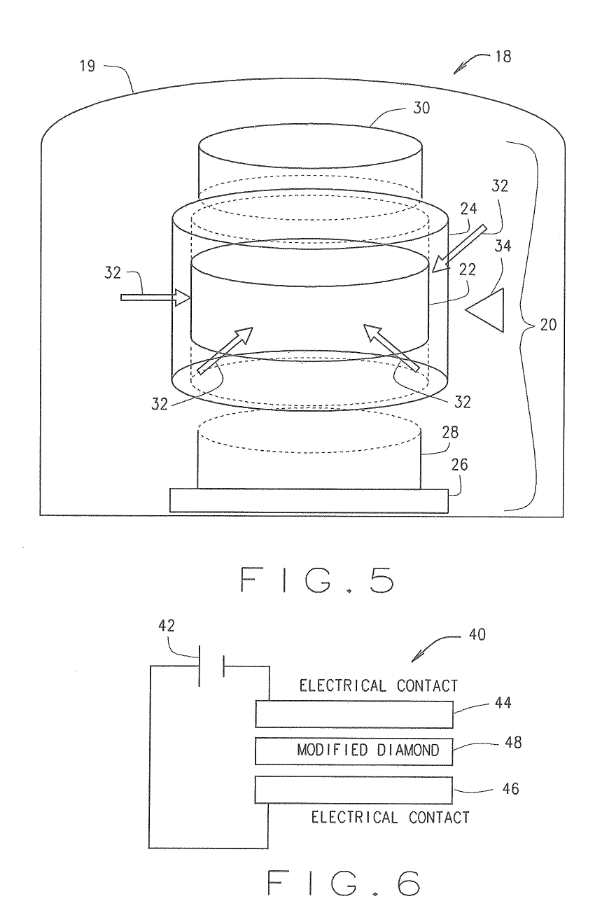

Third, the quartz tube 24 having the sample 22 disposed therein between the electrodes 28 and 30 is placed inside the vacuum chamber 19 (as shown in FIG. 5) wherein the sample 22 is exposed to a vacuum environment of approximately 1×10⁻³ Torr. Fourth, the mixture sample 22 is heated to about 900° C. and substantially simultaneously subjected to one or more 635 nm wavelength laser beams 32 at 3 mW power for about 12 hours while substantially simultaneously having a voltage of approximately 150V applied across the sample 22, via the electrodes 28 and 30. In various embodiments, four laser beams 32 are directed at the diamond/dopant sample 22 and are spaced evenly about the quartz tube 24 at 90 degree intervals. After the sample has been exposed to the 900° C. heat, the one or more 635 nm wavelength lasers beams 32, the 150 V voltage and the compressive pressure applied by the electrodes 28 and 30 for 12 hours, the CrCl is diffused within the diamond material, thereby resulting in a luminescent diamond composite structure 48 (shown in FIG. 6). In various embodiments, each laser beam 32 is generated to have a diameter sufficient to encompass the silhouette of the sample 22.

FIG. 6 illustrates an exemplary illumination device 40 that is structured and operable to provide broadband white light utilizing the luminescent diamond composite structure 48 fabricated using the diffusion device 18, as described above. In various embodiments, the illumination device 40 includes a pair of electrical contacts 44 and 46 that are in electrical contact with the luminescent diamond composite structure 48 such that a voltage can be applied across the diamond composite structure 48. To apply such a voltage across the diamond composite structure 48, via the electrical contacts 44 and 46, the electrical contacts 44 and 46 are structure to be electrically connectable to a power source 42, e.g., a DC or AC power source. More particularly, the application of a voltage across the diamond composite structure 48, via the electrical contacts 44 and 46 and power source 42, will cause the diamond composite structure 48 to illuminate, thereby providing broadband white light. The luminescence intensity of the light emitted by the diamond composite structure 48 can readily be adjusted by changing the voltage-current applied across the diamond composite structure 48.

Furthermore, the light so emitted from the diamond composite structure 48 is created, or generated, via the optical and electrical phenomenon in which a material emits light in response to an electric current passed through it, or to a strong electric field. Hence, such light emission is distinct from light emission resulting from heat as in incandescence lighting. As described herein, the illumination device 40, including the diamond composite structure 48 fabricated as described herein, is capable of emitting white light (with a broad wavelength, e.g., within the white light spectrum), in contrast to the narrow wavelength light emitted by LED's, e.g., between 380 nm and 750 nm. Additionally, due to the properties of diamond materials, such as hardness, the illumination device 40, including the diamond composite structure 48 fabricated as described herein, can produce a light source with long lifespan. Furthermore, the illumination device 40, including the diamond composite structure 48 fabricated as described herein, can be disposed within cases, e.g., glass or transparent plastic bulbs, of variety sizes and shapes, thereby providing a light source with size flexibility that is suitable for a variety of applications. For example, the illumination device 40, including the diamond composite structure 48 fabricated as described herein, can be fabricated at a nano scale, if desired, which can be easily populated onto printed circuit boards. That is, the diffusion device 18 and methods for fabricating the luminescent diamond composite structure 48 using the diffusion device 18, as described above, can be employed to diffuse dopants of several powder sizes, including nanometer size particles, within a hosting material, e.g., a diamond powder, comprising generally any size particles, including nanometer size particles, to produce nano size diamond composite structures 48 that can be used for various nano-particle applications.

Moreover, the diffusion device 18 and method for fabricating the luminescent diamond composite structure 48 using the diffusion device 18, as described above, provides devices and methods technique for producing a heavily doped material (such as diamond composites) that is nondestructive to the microstructure of the host material, e.g., the diamond material. For example, the doping level achieved for boron, can be as high as 12,000 parts per million, which is a concentration far larger than the concentration provided by any known boron doping method.

Still further, the diffusion device 18 and method for fabricating the luminescent diamond composite structure 48 using the diffusion device 18, as described above, can be used for the diffusion of gases, such as Hydrogen and Nitrogen, into an intended material (such as diamond material).

Hence, the diffusion device 18 and method for fabricating the luminescent diamond composite structure 48 using the diffusion device 18, as described above, provide a novel method and means for emitting light from a diamond composite comprising diamond materials diffused with metal dopants, e.g., transition metal dopants. Additionally, the present disclosure provides novel devices and methods for providing broadband white light by providing a driving voltage and current flows across the luminescent diamond composite structure 48 comprising diamond materials diffused with metal dopants, e.g., transition metal dopants, using the diffusion device 18, as described above. Furthermore, the novel methods for providing the broadband white light, via the luminescent diamond composite structure 48, as described herein, can further include the steps of 1) pressing the diamond composite structure 48 into a pellet of a preselected size and shape and 2) placing the doped diamond pellet 48 between the electrical contacts 44 and 46. It is envisioned that a further advantage of the diamond composite structure 48, fabricated via the diffusion device 18 and the methods described herein, is that the diamond composite structure 48 is completely recyclable for use in subsequent illumination devices 40 after the contacts 44 and 46 of an initial illumination device 40 have oxidized or corroded and are no longer suitable for providing a voltage across the diamond composite structure 48.

While the present disclosure has been described in connection with the various embodiments described above, it will be understood that the methodology, as described above, is capable of further modifications. This patent application is intended to cover any variations, uses, or adaptations of the present disclosure following, in general, the principles of the present disclosure and including such departures from the present disclosure as come within known or customary practice within the art to which the present disclosure pertains and as can be applied to the essential features herein before set forth and as follows in scope of the appended claims.

1. (canceled)

2. (canceled)

3. (canceled)

4. (canceled)

5. A method of diffusing a metal dopant into a hosting material, said method comprising:
mixing a metal dopant with a hosting material to obtain a mixture sample;
subjecting the mixture sample to a preselected vacuum for a preselected period of time, via vacuum chamber of a diffusion device;
subjecting the mixture sample to heat of a preselected temperature for the preselected period of time, via a heating element of the diffusion device;
subjecting the mixture sample to at least one laser beam of a preselected wavelength for the preselected period of time, via at least one laser source of the diffusion device; and
subjecting the mixture sample to a preselected voltage applied across the mixture sample for the preselected period of time, via a pair of opposing electrodes of the diffusion device, such that a resulting doped composite structure is produced having a high concentration of the metal dopant.

6. The method of claim 1 further comprising compacting the mixture sample to provide a sample tablet prior to subjecting the mixture sample mixture sample to the vacuum, the heat, the at least one laser and the voltage for the preselected period of time.

7. The method of claim 1 further comprising applying a compressive force to the mixture sample as the mixture sample is subjected to the vacuum, the heat, the at least one laser and the voltage for the preselected period of time.

8. The method of claim 1, wherein mixing the metal dopant with the hosting material comprises mixing the metal dopant with a diamond material such that the resulting doped composite structure comprises a luminescent diamond composite structure that will emit a broadband white light when a voltage is applied across the luminescent diamond composite structure.

9. The method of claim 8, wherein mixing the metal dopant with the diamond material comprises mixing the metal dopant with the diamond material and subjecting the diamond/dopant mixture sample to the vacuum, the heat, the at least one laser and the voltage for the preselected period of time such that the resulting luminescent diamond composite structure comprises a concentration of the metal dopant of approximately 100 ppm to 5,000 ppm.

10. The method of claim 8, wherein mixing the at least one metal dopant with the diamond material comprises mixing the metal dopant with one of a diamond powder and a diamond film to obtain mixture sample.

11. The method of claim 8, wherein mixing the metal dopant with a diamond material comprises mixing at least one transition metal with the diamond material such that the resulting doped composite structure comprises a luminescent diamond composite structure that will emit a broadband white light when a voltage is applied across the luminescent diamond composite structure.

12. A diffusion device, said device comprising:
a vacuum chamber structured and operable to subject a mixture sample to a preselected vacuum for a preselected period of time, the mixture sample comprising a metal dopant mixed with a hosting material;
a heating element structured and operable to subject the mixture sample to heat of a preselected temperature for the preselected period of time;
at least one laser source structured and operable to subject the mixture sample to at least one laser beam of a preselected wavelength for the preselected period of time; and
a pair of opposing electrodes structured and operable to subject the mixture sample to a preselected voltage applied across the mixture sample for the preselected period of time such that a resulting doped composite structure is produced having a high concentration of the dopant diffused into the hosting material.

13. The device of claim 12 further comprising a pair of biasing devices, each biasing device structured and operable to apply a force a respective one of the electrodes to apply a compressive force to the mixture sample as the mixture sample is subjected to the vacuum by the vacuum chamber, the heat by the heating element, the at least one laser by the at least one laser source and the voltage by the electrodes for the preselected period of time.

14. The device of claim 12, wherein the metal dopant comprises at least one metal and the hosting material comprises a diamond material such that the resulting doped composite structure comprises a luminescent diamond composite structure that will emit a broadband white light when a voltage is applied across the luminescent diamond composite structure.

15. The device of claim 14, wherein the luminescent diamond composite structure comprises a concentration of the metal dopant of approximately 100 ppm to 5,000 ppm.

16. The device of claim 14, wherein that at least one metal comprises at least one transition metal.

17. An illumination device that will emit a broadband white light, said device comprising:
a pair of opposing electrical contacts connectable to a power source; and
a luminescent diamond composite pellet disposed between, and in electrical contact with, the opposing electrical contacts, wherein the luminescent diamond composite pellet comprises at least one metal dopant diffused into a diamond material, and wherein the luminescent diamond composite pellet will emit a broadband white light when opposing electrical contacts are connected to a power source and a voltage is applied across the luminescent diamond composite structure.

18. The device of claim 17, wherein the diamond material comprises a diamond powder.

19. The device of claim 17, wherein the diamond material comprises a diamond film.

20. The device of claim 17, wherein the luminescent diamond composite structure comprises a concentration of the at least one metal dopant of approximately 100 ppm to 5,000 ppm.

21. A method of producing an illumination device that will emit a broadband white light, said method comprising:
mixing at least one transition metal with a diamond material to obtain a mixture sample;
subjecting the mixture sample to a preselected vacuum for a preselected period of time, via vacuum chamber of a diffusion device;
subjecting the mixture sample to heat of a preselected temperature for the preselected period of time, via a heating element of the diffusion device;
subjecting the mixture sample to at least one laser beam of a preselected wavelength for the preselected period of time, via at least one laser source of the diffusion device;
subjecting the mixture sample to a preselected voltage applied across the mixture sample for the preselected period of time, via a pair of opposing electrodes of the diffusion device such that a resulting luminescent diamond composite structure is produced having a high concentration of the at least one transition metal; and
pressing the luminescent diamond composite structure into a pellet of a desired size and shape; and
fixedly disposing the luminescent diamond composite pellet between a set of electrical contacts that are structured to be connectable to a power source such that a voltage can selectively be applied across the luminescent diamond composite pellet, whereby the luminescent diamond composite pellet will emit a broadband white light.

22. The method of claim 21, wherein mixing the at least one transition metal with the diamond material comprises mixing at least one transition metal with a diamond powder to obtain a substantially homogenous mixture sample.

23. The method of claim 21 further comprising compacting the substantially homogenous mixture sample to provide a sample tablet prior to subjecting the compacted substantially homogenous mixture sample to the vacuum, the heat, the at least one laser and the voltage for the preselected period of time.

24. The method of claim 21, wherein mixing the at least one transition metal with the diamond material comprises mixing the at least one transition metal with a diamond film.

25. The method of claim 21 further comprising applying a compressive force to the mixture sample as the mixture sample is subjected to the vacuum, the heat, the at least one laser and the voltage for the preselected period of time.

26. The method of claim 21, wherein mixing the transition metal dopant with the diamond material comprises mixing the transition metal dopant with the diamond material and subjecting the diamond/dopant mixture sample to the vacuum, the heat, the at least one laser and the voltage for the preselected period of time such that the resulting luminescent diamond composite structure comprises a concentration of the at least one transition metal of approximately 100 ppm to 5,000 ppm.
